(19) United States
(12) Patent Application Publication
(10) Pub. No.: US 2015/0244972 A1
(43) Pub. Date: Aug. 27, 2015

(54) METHODS AND SYSTEMS FOR DETERMINING LENGTHS OF TIME FOR RETAINING MEDIA ASSETS

(71) Applicant: UNITED VIDEO PROPERTIES INC., SANTA CLARA, CA (US)

(72) Inventors: Alejandro S. Pulido, Chatsworth, CA (US); Michael R. Nichols, La Canada Flintridge, CA (US); Walter R. Klappert, Los Angeles, CA (US)

(73) Assignee: UNITED VIDEO PROPERTIES INC., SANTA CLARA, CA (US)

(21) Appl. No.: 14/191,748

(22) Filed: Feb. 27, 2014

(51) Int. Cl. H04N 5/91; H04N 21/231; H04N 21/4335; H04N 5/85

(52) U.S. Cl. CPC H04N 5/91; H04N 5/85; H04N 21/23113; H04N 21/4335

(57) ABSTRACT

Methods and systems are disclosed herein for a media guidance application that automatically manages the storage and deletion of media assets received by a user. For example, based on the source, content, context, file type, size, current storage capabilities, or another characteristic of the media asset, the media guidance application may determine a length of time to retain the media asset.

### BACKGROUND

Conventional media systems allow users access to a plethora of media content. Moreover, the expanded storage capabilities offered by DVR's, computer hard drives, cloud-based systems allow users to store seemingly unlimited amounts of content. Often the amount of content received by a user, and subsequently stored, may become overwhelming. While a user may wish to delete some media content, the user may not have the time or enthusiasm to review each received media asset to determine whether or not it should continue to be stored.

### SUMMARY

Accordingly, methods and systems are disclosed herein for a media guidance application that automatically manages the storage and deletion of media assets received by a user. Specifically, the media guidance application may determine a length of time to retain the media asset based on the characteristics associated with the media asset. For example, based on the source, content, context, (e.g., one or more circumstances associated with creation or transmission), file type, size, current storage capabilities, or another characteristic of the media asset, the media guidance application may determine a length of time to retain the media asset.

For example, a media guidance application may detect a received media asset at an account of a user (e.g., a posting to a social network account associated with the user). The media guidance application may then identify whether the entity from which it was received is an advertiser, a content provider, or another user (e.g., a friend of the user). Based on the identity of the source, the media guidance application may determine a length of time, if any, to retain the media asset and/or present a media asset identifier (e.g., a media listing, post, link, etc.) for the media asset in the account.

In some aspects, the media guidance application receives, at an account associated with a user, a media asset addressed to the user from an entity. The media guidance application may then identify, using processing circuitry, a class of the entity based on a comparison of the entity with a contacts list associated with the user, in which the contacts lists is stored in storage circuitry associated with the account. The media guidance application may cross-reference, using the processing circuitry, the class with a database listing lengths of time for retaining content from different classes to determine a length of time to retain the media asset, and store the media asset in the storage circuitry for the determined length of time.

In some embodiments, the media guidance application may further determine an actual length of time the media asset has been stored and compare the actual length of time the media asset has been stored to the determined length of time. In response to determining that the actual length of time the media asset has been stored corresponds to the determined length of time, the media guidance application may delete the media asset from the storage circuitry.

In some embodiments, the media guidance application may determine a length of time, or modify a determined length of time, to retain a media asset based on one or more characteristic of a media asset such as the source, content, context, file type, size, current storage capabilities, etc. For example, based on one or more characteristics of the media asset, the media guidance application may determine that a user would prefer to retain a media asset for more or less time.

In some embodiments, the media guidance application may identify a keyword associated with the media asset and compare the keyword to a user preference for keywords. The media guidance application may determine a length of time, or modify a determined length of time, to retain the media asset based on the keyword comparison. For example, the media guidance application may compare the content of the media asset for keywords that indicate a user may prefer to retain the media asset for more or less time.

In some embodiments, the media guidance application may identify a context associated with the media asset and compare the context to a user preference for contexts. The media guidance application may determine a length of time, or modify a determined length of time, to retain the media asset based on the context comparison. For example, the media guidance application may determine that based on context of a media asset that a user may prefer to retain the media asset for more or less time.

In some embodiments, the media guidance application may identify a file type associated with the media asset and compare the file type to a user preference for file types. The media guidance application may determine a length of time, or modify a determined length of time, to retain the media asset based on the file type comparison. For example, the media guidance application may determine that a user prefers to keep a specific type of file for a specific amount of time.

In some embodiments, the media guidance application may identify a storage requirement associated with the media asset and compare the storage requirement to a user preference for storage requirements. The media guidance application may determine a length of time, or modify a determined length of time, to retain the media asset based on the storage requirement comparison. For example, the media guidance application may determine that a user prefers to retain large files for a less amount of time than small files.

In some embodiments, the media guidance application may determine a length of time, or modify a determined length of time, to retain the media asset based on whether or not a user accesses a received media asset. For example, if a user accesses a media asset (e.g., within a predetermined amount of time), the media guidance application may determine that a user prefers to keep the media asset (e.g., because the user found the media asset interesting enough to access) or prefers to delete the media asset (e.g., because the user has already viewed the media asset). Alternatively or additionally, if a media asset is not accessed for a particular amount of time after it has been received, the media guidance application may determine a length of time to retain the media asset, delete the media asset, or determine one or more characteristics about the media asset for use in determining a length of time to retain the media asset.

It should be noted, the systems and/or methods described above may be combined with, applied to, or used in accordance with, other systems, methods and/or apparatuses discussed both above and below.

### BRIEF DESCRIPTION OF THE DRAWINGS

The above and other objects and advantages of the disclosure will be apparent upon consideration of the following detailed description, taken in conjunction with the accompanying drawings, in which like reference characters refer to like parts throughout, and in which:

FIG. 1 shows an illustrative example of a media guidance display for navigating and selecting media assets in accordance with some embodiments of the disclosure;

FIG. 2 shows another illustrative example of a media guidance display for navigating and selecting received media assets in accordance with some embodiments of the disclosure;

FIG. 3 is a block diagram of an illustrative user equipment device in accordance with some embodiments of the disclosure;

FIG. 4 is a block diagram of an illustrative media system in accordance with some embodiments of the disclosure;

FIG. 5 is a flowchart of illustrative steps for determining a length of time to store a media asset based on the entity from which it was received in accordance with some embodiments of the disclosure; and

FIG. 6 is a flowchart of illustrative steps for modifying a determined length of time for storing a media asset based on characteristics associated with the media asset in accordance with some embodiments of the disclosure.

### DETAILED DESCRIPTION OF THE DRAWINGS

Methods and systems are disclosed herein for a media guidance application that automatically manages the storage and deletion of media assets received by a user. As used herein, “a media guidance application,” “interactive media guidance application,” or “guidance application” refer to a form of media guidance through an interface that allows users to efficiently navigate, identify, view, playback, and/or obtain information about content that they may desire. In some embodiments, the media guidance application may be provided as an on-line application (i.e., provided on a website), or as a stand-alone application on a server, user device, etc. Various devices and platforms that may implement the media guidance application are described in more detail below. In some embodiments, the media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media card, register memory, processor caches, Random Access Memory (“RAM”), etc.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content. As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, Webcasts, etc.), video clips, audio, content information, pictures, rotating images, documents, playlists, websites, articles, books, electronic books, blogs, advertisements, chat sessions, social media, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

In some embodiments, the media guidance application may determine a length of time to retain the media asset based on the characteristics associated with the media asset. As referred to herein, a “characteristic” is any attribute of a media asset that may be classified, identified, and/or used to distinguish one media asset from another. For example, based on the source, content, context, file type, size, current storage capabilities, or another characteristic of the media asset, the media guidance application may determine a length of time to retain the media asset. In some embodiments, the media guidance application may determine a length of time to retain the media asset based on multiple characteristics associated with a media asset.

In some embodiments, the characteristics associated with a media asset may be determined prior to, concurrently with, or after receiving a media asset. For example, the media guidance application may receive data describing the characteristics of all available media assets. In another example, the media guidance application may receive data associated with the media asset (e.g., metadata) that indicates the characteristics of the media asset. In yet another example, the media guidance application may determine the characteristics of a media asset by processing the media asset.

For example, the media guidance application may determine the characteristics associated with the media asset by applying one or more content recognition techniques to the media asset. For example, the media guidance application may use a content recognition module or algorithm to generate data describing the context, content, and/or any other data necessary for determining a characteristic of a media asset. For example, the content recognition module may use object recognition techniques such as edge detection, pattern recognition, including, but not limited to, self-learning systems (e.g., neural networks), optical character recognition, on-line character recognition (including but not limited to, dynamic character recognition, real-time character recognition, intelligent character recognition), and/or any other suitable technique or method to determine objects in the media asset. For example, the media guidance application may receive data in the form of a video. The video may include a series of frames. For each frame of the video, the media guidance application may use a content recognition module or algorithm to determine the objects (e.g., people, places, things, etc.) in each of the frames or series of frames, which may be used to determine a characteristic of the media asset. For example, based on the detection of a multitude of explosions in the frames, the media guidance application may determine the circumstances of the media asset include action scenes. The media guidance application may then compare this determination to the user preference criteria to determine how long the user prefers to retain media asset containing action scenes and/or the action genre.

In some embodiments, the content recognition module or algorithm may also include speech recognition techniques, including, but not limited to, Hidden Markov Models, dynamic time warping, and/or neural networks (as described above) to translate spoken words into text and/or processing audio data. The content recognition module may also combine multiple techniques to determine whether or not a media asset is consistent with user preferences.

In addition, the media guidance application may use multiple types of optical character recognition and/or fuzzy logic, for example, when processing keyword(s) retrieved from data (e.g., textual data, translated audio data, user inputs, etc.) describing the media asset (or when cross-referencing various types of data in databases). For example, if the particular data received is textual data, using fuzzy logic, the media guidance application (e.g., via a content recognition module or algorithm incorporated into, or accessible by, the media guidance application) may determine two fields and/or values to be identical even though the substance of the data or value (e.g., two different spellings) is not identical. In some embodiments, the media guidance application may analyze particular received data of a data structure or media asset frame for particular values or text using optical character recognition methods described above in order to determine a characteristic of a media asset. For example, the media guidance application may process subtitles of the media asset to find particular characters or events that occur in the media asset and compare the finding to user preference to determine how long, if at all, to retain a media asset.

For example, in some embodiments, the media guidance application may determine that based on the characteristics associated with a media asset, the media asset should be deleted immediately and/or immediately transferred to a temporary storage device and/or buffer. In such cases, the media guidance application may notify the user that the media asset will be deleting in a certain amount of time unless an input is received from the user within that amount of time.

In some embodiments, a characteristic may include a keyword. For example, the media guidance application may identify a keyword associated with the media asset and compare the keyword to a user preference for keywords. The media guidance application may determine a length of time, or modify a determined length of time, to retain the media asset based on the keyword comparison. For example, the media guidance application may compare the content of the media asset for keywords (e.g., names of characters, objectionable content, etc.) that indicate a user may prefer to retain the media asset for more or less time.

For example, user preferences may indicate a default black-list and a default white-list of keywords. Words such as “sports,” “music,” and “science,” may be divided between the lists according to the general likes and dislikes of a user and/or a demographic of the user. Additionally or alternatively, words associated with sources of content may also be in the startup default black and white-lists as well as proper names such as celebrities' names, names of local or national politicians, or product names may be in default black and white-lists as well.

In some embodiments, the media guidance application may modify default lists based on user actions (e.g., based on media assets with specific keywords that a user rejected or automatically had deleted after a short period of time). Additionally or alternatively, special settings may be invoked when media is shared within a particular proximity (e.g., between two devices with a particular length or at the same location). In some embodiments, media assets might be accepted by your device in spite of a black-list match, or at least appear to accept the media asset (e.g., temporarily post a message on a social network site of a user). If accepted, after a short period of time the system would automatically delete this black-listed media asset.

In some embodiments, a characteristic may include a context of a media asset. For example, the media guidance application may identify a context associated with the media asset and compare the context to a user preference for contexts. The media guidance application may determine a length of time, or modify a determined length of time, to retain the media asset based on the context comparison. In some embodiments, the media guidance application may make determinations based on multiple characteristics. For example, the media guidance application may determine that, based on context of a media asset, a user may prefer to retain the media asset for more or less time. For example, the media guidance application may determine that the context of a media asset (e.g., a joke) negates the effect of one or more keywords appearing on a black-list of a user.

In some embodiments, a characteristic may include a file type of a media asset. For example, the media guidance application may identify a file type associated with the media asset and compare the file type to a user preference for file types. The media guidance application may determine a length of time, or modify a determined length of time, to retain the media asset based on the file type comparison. For example, the media guidance application may determine that a user prefers to keep a specific type of file for a specific amount of time. In some embodiments, the media guidance application may make determinations based on multiple characteristics. For example, the media guidance application may apply particular white and black-lists based on the file type of the media asset.

In some embodiments, a characteristic may include a storage requirement of a media asset. For example, the media guidance application may identify a storage requirement associated with the media asset and compare the storage requirement to a user preference for storage requirements. The media guidance application may determine a length of time, or modify a determined length of time, to retain the media asset based on the storage requirement comparison. For example, the media guidance application may determine that a user prefers to retain large files for a less amount of time than small files. In some embodiments, the media guidance application may make determinations based on multiple characteristics. For example, the media guidance application may allow more or less keywords that correspond to a white or black-list based on the media asset that is a particular size or of a particular length.

In some embodiments, the media guidance application may determine a length of time, or modify a determined length of time, to retain the media asset based on whether or not a user accesses a received media asset. For example, if a user accesses a media asset (e.g., within a predetermined amount of time), the media guidance application may determine that a user prefers to keep the media asset (e.g., because the user found the media asset interesting enough to access) or prefers to delete the media asset (e.g., because the user has already viewed the media asset). Alternatively or additionally, if a media asset is not accessed for a particular amount of time after it has been received, the media guidance application may determine a length of time to retain the media asset, delete the media asset, or determine one or more characteristics about the media asset for use in determining a length of time to retain the media asset.

It should be noted that in embodiments discussed throughout this disclosure “a length of time” may be measured in any temporal unit (e.g., seconds, minutes, days, years, etc.). In addition, a length of time may include the length of time that is required for the performance of one or more events. For example, the media guidance application may determine, based on one or more characteristics of a media asset, to retain a media asset until a user accesses an account associated with the media asset five times without accessing the media asset. In another example, the media guidance application may determine, based on one or more characteristics of a media asset, to retain a media asset until a user receives ten different media assets, or ten different media assets of a specific type, subsequent to receiving the stored media asset. In such cases, the media guidance application may define the triggering events and/or the number of triggering events that is required to delete the received media asset prior to, concurrently with, or subsequent to receiving the media asset.

In some embodiments, the media guidance application may receive a media asset at a user device, storage location, or account associated with a user. For example, a media guidance application may detect a received media asset on a social network page associated with the user, a computer, set-top box, or smartphone associated with the user, or a voice-mail, e-mail, text message account associated with the user. The media guidance application may then determine a length of time to retain the media asset and/or present a media asset identifier (e.g., a media listing, post, link, etc.) for the media asset based on one or more characteristics of the media asset.

In some embodiments, the media guidance application may determine a length of time, or modify a determined length of time, to retain a media asset based on one or more characteristic of a media asset such as the source, content, context, file type, size, current storage capabilities, etc. For example, based on one or more characteristics of the media asset, the media guidance application may determine that a user would prefer to retain a media asset for more or less time.

For example, the media guidance application may determine how long to store a media asset based on the entity from which it came. As referred to herein, an “entity” may refer to any person, place, third party, or, thing that may be associated with a source of a media asset. For example, an entity may include an advertiser, a content provider, or another user (e.g., a friend of the user). In such cases, the media guidance application may further determine a class associated with the entity. As referred to herein, a “class” is a grouping of one or more entities for which the media audience application determines that a media asset received from these one or more entities should be kept for the same amount of time. For example, a class may include all advertisers for which a media asset received from them is kept for five days. A class may refer to a group of users for which a media asset received from them is kept for three days. A class may include all content providers and friends for which media assets are kept for an unlimited amount of time. A class may include a demographic, social networking, or familial relationship for which media assets received from entities having this relationship are kept for a particular length of time.

The media guidance application may identify an entity and/or a class of a media asset through a variety of means. For example, the media guidance application may process an entity identifier associated with the entity. As user herein, “an entity identifier” is any type of indication, which identifies the identity of the entity to the media guidance application. For example, the entity's identity may be conveyed in an entity identifier in Application Program Interface (“API”) calls. In another example, the entity identifier may be a serial number received by the media guidance application. The media guidance application may then cross-reference the serial number with a database listing serial numbers associated with entities to determine the particular entity. In another example, the entity identifier may include a file, password, or any other data used by the media guidance application to verify the identity of the entity.

In some embodiments, upon identifying an entity, the media guidance application may determine a class of the entity by comparing the entity to a list of contacts of a user. The presence of the entity on one or more lists, or the relationship connoted by the presence of the entity on a particular list may define a class of a user. For example, the media guidance application may retrieve a list of friends (e.g., a social network buddy list), contacts (e.g., retrieved from a phone/text message/e-mail account associated with the user), and/or other listings featuring other entities with known associations to the user. Based on this, the media guidance application may determine a class of the entity. For example, one class may correspond to entities found in a user's e-mail contacts, another class may correspond to entities found to be associated with a social network of a user (e.g., friends of a user in a particular social network), and yet another class may correspond to entities with no known associations to the user.

As used herein, a “social network,” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by social media provider may make content (e.g., status updates, microblog posts, images, graphic messages, etc.) associated with a first user accessible to a second user that is within the same social network as the first user. In such cases, classes of entities may correspond to the level of access and/or the amount or type of content associated with a first user that is accessible to a second user.

In some embodiments, the media guidance application receives, at an account associated with a user, a media asset addressed to the user from an entity. For example, the account may be associated with a social network, voice mail, text, e-mail, etc. account associated with a user. The media guidance application may then identify, using processing circuitry, a class of the entity based on a comparison of the entity with a contacts list associated with the user, in which the contacts list is stored in storage circuitry associated with the account. As referred to herein, a “contacts list” refers to any collection of names of entities and an account of a user. In some embodiments, the contacts list used may be a contacts list associated with a particular account. For example, an entity from which a media asset of a particular type (e.g., an e-mail) is received may be compared to a contacts list associated with that particular type (e.g., a contacts list associated with an e-mail account), whereas an entity from which a media asset of a different type (e.g., a post on a social network page associated with a user) is received may be compared to a contacts list associated with that particular type (e.g., a contacts list associated with the social network).

In some embodiments, the media guidance application may cross-reference, using the processing circuitry, the class with a database listing lengths of time for retaining content from different classes to determine a length of time to retain the media asset, and store the media asset in the storage circuitry for the determined length of time.

In some embodiments, the media guidance application may further determine an actual length of time the media asset has been stored and compare the actual length of time the media asset has been stored to the determined length of time. In response to determining that the actual length of time the media asset has been stored corresponds to the determined length of time, the media guidance application may delete the media asset from the storage circuitry. For example, the media guidance application may incorporate a clock or counter function or applications that track the actual length of time that a media asset has been stored. As described below, the value (e.g., in units of time) associated with the clock or counter function may be compared with the determined length of time.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), genre or category information, actor information, logo data for broadcasters' or providers' logos, etc.), media format (e.g., standard definition, high definition, 3D, etc.), advertisement information (e.g., text, images, media clips, etc.), on-demand information, blogs, websites, and any other type of guidance data that is helpful for a user to navigate among and locate desired content selections.

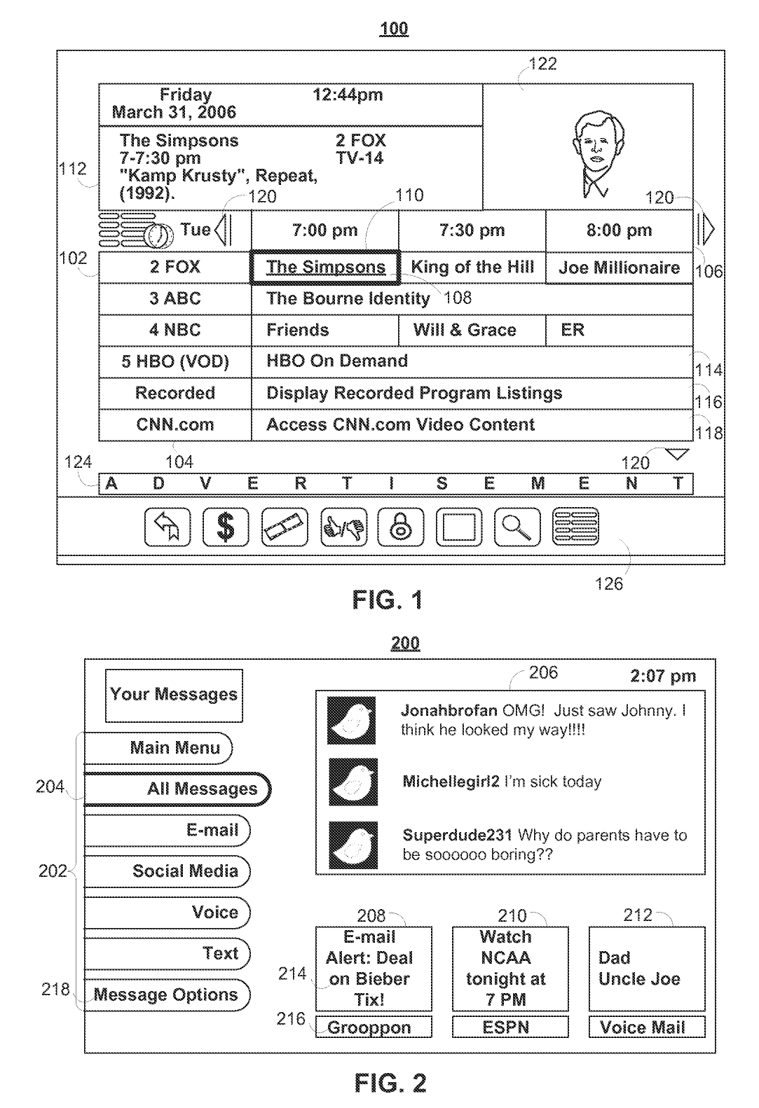

FIGS. 1-2 show illustrative display screens that may be used to provide media guidance data. The display screens shown in FIGS. 1-2 may be implemented on any suitable user equipment device or platform. While the displays of FIGS. 1-2 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, and other desired information.

In addition to providing access to linear programming (e.g., content that is scheduled to be transmitted to a plurality of user equipment devices at a predetermined time and is provided according to a schedule), the media guidance application also provides access to non-linear programming (e.g., content accessible to a user equipment device at any time and is not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet web site or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different than display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other air times or ways of receiving a program, recording a program, enabling series recording of a program, setting program and/or channel as a favorite, purchasing a program, or other features. Options available from a main menu display may include search options, VOD options, parental control options, Internet options, cloud-based options, device synchronization options, second screen device options, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media assets, e-mail, electronically delivered articles, etc.) and other desired customizations.

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other web sites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

Another display arrangement for providing media guidance is shown in FIG. 2. Video mosaic display 200 includes selectable options 202 for use in navigating to and selecting various options associated with received messages. For example, selectable options 202 provides links for navigating the main menu as well as links to available messages based on the type of the message. For example, in response to a user input requesting text messages, the media guidance application may display all text messages.

In display 200, selectable option 204 is selected, thus providing social media messages 206, e-mail messages 208, television messages 210, and voice messages 212. In display 200 the messages may provide graphical images including cover art, still images from the content, video clip previews, live video from the content, or other types of content that indicate to a user the content being described. Each of the messages may also be accompanied by text to provide further information about the content associated with the listing. For example, e-mail messages 208 may include more than one portion, including media portion 214 and text portion 216, which indicates one or more characteristics of the media asset (e.g., an entity from which it was received). Media portion 214 and/or text portion 216 may be selectable to view content in full-screen or to view information related to the content displayed in media portion 214 (e.g., all characteristics associated with the media asset).

The listings in display 200 are of different sizes (i.e., social media messages 206 is larger than e-mail message 208, television message 210, and voice message 212), but if desired, all the messages may be the same size. Messages may be of different sizes or graphically accentuated to indicate degrees of interest to the user or to emphasize certain content, as desired by the content provider or based on user preferences. Various systems and methods for graphically accentuating media assets are discussed in, for example, Yates, U.S. Patent Application Publication No. 2010/0153885, filed Dec. 29, 2005, which is hereby incorporated by reference herein in its entirety.

Display 200 also includes selectable option 218, which may allow users to define user preferences and/or select options associated with the storage of one or more contents. For example, in response to receiving a user selection of selectable option 218, the media guidance application may generate a display that allows a user to select lengths of time for storing various media assets based on one or more characteristics and/or any other settings associated with the storage of media assets. In another example, the media guidance application may generate a display that allows a user to review known entities (e.g., entities from which the user has received media assets), contact lists featuring various entities and the classes associated with the various entities, and/or any other any settings (e.g., including user preferences) related to the various entities and classes.

For example, the media guidance application may receive user instructions designating that all media assets received from entities (e.g., other users) that are in a particular class (e.g., associated with the user via a particular social network and/or a relationship status on the particular social network) are retain for a particular amount of time as well as other characteristics (e.g., file size, file type, etc.) that may affect the retention period of the media asset.

For example, the media guidance application may receive user instructions to add or remove one or more keywords from a black or white list. Furthermore, the media guidance application may receive user instructions to modify a weight associated with a keyword and/or any other characteristic. The media guidance application may receive user instructions related to how, and/or if, the media guidance application should automatically or in response to a user request, respond to a received message.

For example, the media guidance application may generate a read receipt and/or delivery receipt to a user that indicates to the entity that transmitted the message that the user account has received the message. In some embodiments, the media guidance application may further customize the responses based on one or more criteria selected by a user. For example, the media guidance application may generate custom responses based on the contact list, if any, an entity is associated with.

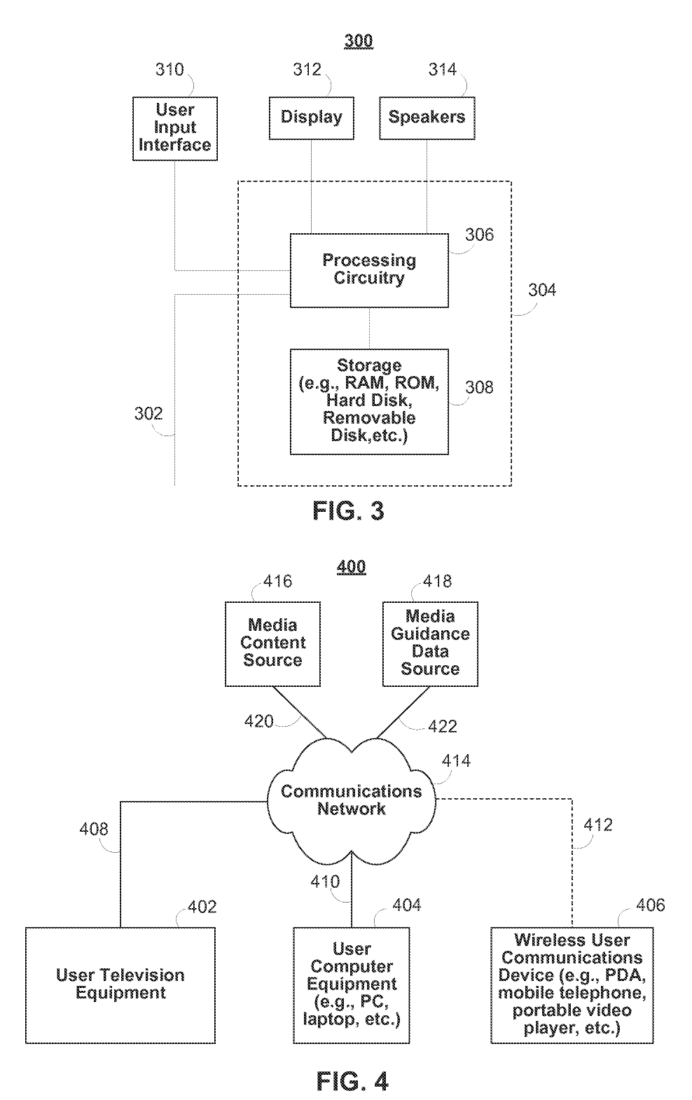

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In client-server based embodiments, control circuitry 304 may include communications circuitry suitable for communicating with a guidance application server or other networks or servers. The instructions for carrying out the above mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which is described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data and guidance application data that are described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, touch screen, touchpad, stylus input, joystick, voice recognition interface, or other user input interfaces. Display 312 may be provided as a stand-alone device or integrated with other elements of user equipment device 300. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature polysilicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a standalone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a web site accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device.

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the web site www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as, a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed). Program schedule data and other guidance data may be provided to the user equipment on a television channel sideband, using an in-band digital signal, using an out-of-band digital signal, or by any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of the remote server. When executed by control circuitry of the remote server (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally-stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

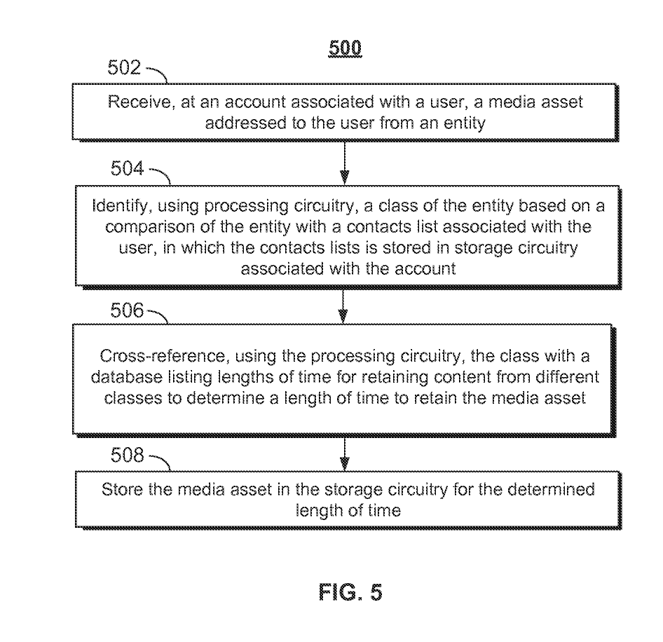

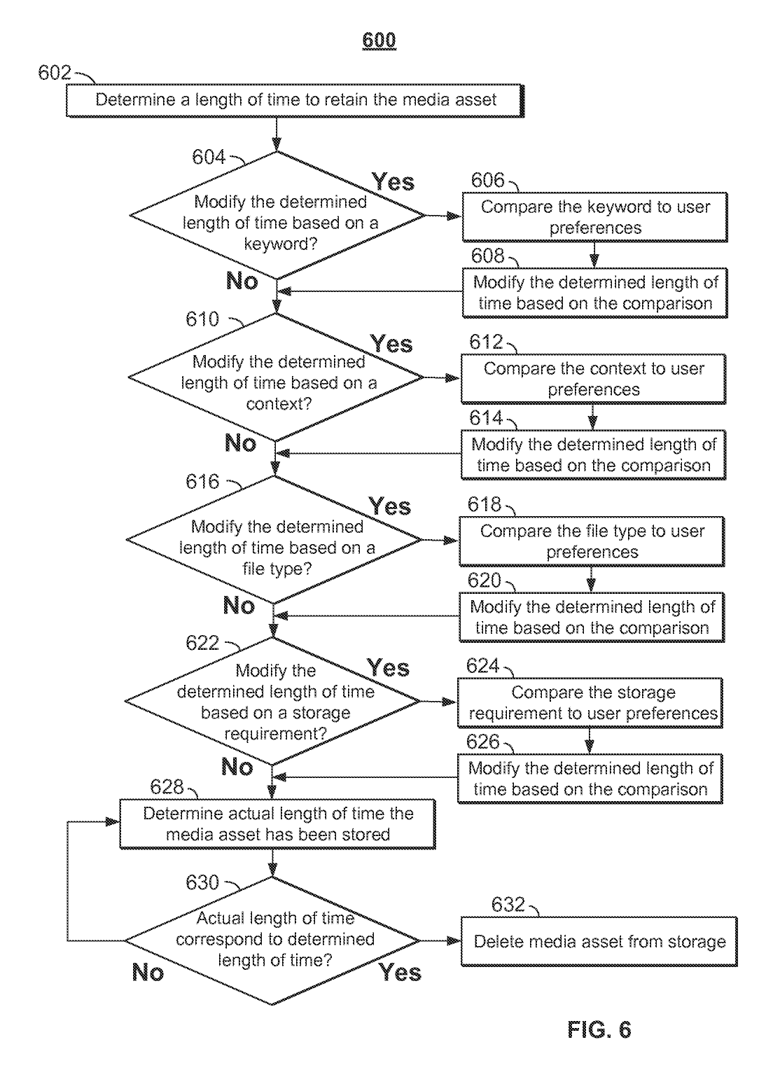

FIG. 5 is a flowchart of illustrative steps for modifying a determined length of time for storing a media asset based on characteristics associated with the media asset. It should be noted that process 500 or any step thereof could be performed on, or provided by, any of the devices shown in FIGS. 3-4. For example, process 500 may be executed by control circuitry 304 (FIG. 3) as instructed by a media guidance application implemented on a user device (e.g., user equipment devices 402, 404, and/or 406 (FIG. 4)) in order to determine whether to retain media assets (e.g., as discussed in relation to FIGS. 1-2). In addition, one or more steps of process 500 may be incorporated into or combined with one or more steps of any other process or embodiment (e.g., process 600 (FIG. 6)).

At step 502, the media guidance application receives, at an account associated with a user, a media asset addressed to the user from an entity. For example, the media guidance application may receive (e.g., via I/O path 302 (FIG. 3)) a media asset (e.g., an e-mail advertisement such as e-mail message 208 (FIG. 2)) that is stored locally (e.g., at storage 308 (FIG. 3)). In another example, the media guidance application may detect that a media asset (e.g., social media messages 206 (FIG. 2)) has been received at an account of a user (e.g., a social media account) located on a social network server (e.g., located at content source 416 (FIG. 4) and/or any other location accessible via communications network 414 (FIG. 4)).

For example, the media guidance application may access processing circuitry (e.g., processing circuitry 306 (FIG. 3)) that is configured to receive (e.g., via I/O path 302 (FIG. 3), at an account (e.g., a voice mail account) associated with a user, a media asset (e.g., voice mail 212 (FIG. 2)) addressed to the user from an entity (e.g., another user). In some embodiments, the media guidance application may (e.g., via processing circuitry 306 (FIG. 3)) monitor the various accounts of a user (e.g., accessible via I/O path 302 (FIG. 3)) and/or local (e.g., storage 308 (FIG. 3)) and remote (e.g., located at any location/device accessible via communications network 414 (FIG. 4)) storage locations and/or circuitry for the receipt of media assets. In such cases, the media guidance application may actively (e.g., requesting status updates from the various accounts and storage devices) or passively (receiving incoming message notification from the account and/or storage devices) monitor the accounts and/or storage device in a continuous or periodic manner.

At step 504, the media guidance application may identify, using processing circuitry, a class of the entity based on a comparison of the entity with a contacts list associated with the user, in which the contacts list is stored in storage circuitry associated with the account. For example, the media guidance application may detect (e.g., via processing circuitry 306 (FIG. 3)) an entity identifier associated with the entity. The entity identifier (e.g., a serial number associated with the message, an address from which the message was received, etc.) may indicate the name of the entity that transmitted (e.g., via I/O path 302 (FIG. 3)) the media asset (e.g., television message 210 (FIG. 2)) to the user (or the account and/or storage device associated with the user).

The media guidance application may then compare the name of the user to a contacts list of known entities of the user. Alternatively or additionally, the media guidance application (e.g., via processing circuitry 306 (FIG. 3)) may compare the entity identifier to a contacts list listing known entity identifiers. Based on the presence, or lack thereof, of the name (or entity identifier) of the entity that transmitted the media asset on one or more contacts lists, the media guidance application may determine a class associated with the entity.

For example, if the entity is listed among the known entities on a contacts list of business associates of the user, the media guidance application (e.g., via processing circuitry 306 (FIG. 3)) may assign a class (e.g., work-related messages) to the entity that is associated with business associates of the user. In another example, if the entity is listed among the known entities on a contacts list of family members of the user, the media guidance application (e.g., via processing circuitry 306 (FIG. 3)) may assign a class (e.g., family-related messages) to the entity that is associated with family members of the user. In yet another example, if the entity is not listed among the known entities on any contacts list of the user, the media guidance application (e.g., via processing circuitry 306 (FIG. 3)) may assign a class (e.g., a default class) to the entity that is associated with no know contacts of the user.

In some embodiments, the media guidance application may (e.g., via processing circuitry 306 (FIG. 3)) retrieve the various contacts lists associated with a user from local (e.g., storage 308 (FIG. 3)) and/or remote (e.g., located at any location/device accessible via communications network 414 (FIG. 4)) storage locations and/or circuitry. For example, the media guidance application may retrieve all contacts lists associated with a particular user (or user profile). For example, the media guidance application may retrieve (e.g., via processing circuitry 306 (FIG. 3)) data associated with known contacts of a user from storage circuitry (e.g., storage 308 (FIG. 3)) coupled to, and/or accessible by, the media guidance application.

At step 506, the media guidance application cross-reference, using the processing circuitry, the class with a database listing lengths of time for retaining content from different classes to determine a length of time to retain the media asset. For example, in response to determining a class associated with the entity, the media guidance application may cross-reference the class with a database located locally (e.g., storage 308 (FIG. 3)) or remotely (e.g., media guidance data source 418 (FIG. 4) and/or any location accessible via communications network 414 (FIG. 4)) to determine a length of time for retaining the received media asset.

For example, the database may be a lookup table database, in which the media guidance application input a value (e.g., the class) and, in response, the lookup table database filters the listings in the database such that only listings associated with the inputted value (e.g., the class) are outputted. The outputted values may indicate the length of time that a media asset received from the class of entity should be retained. Additionally or alternatively, the outputted values may indicate any other user preferences associated with the class. For example, the user preference for the class may indicate particular keywords, files sizes, files types, and/or any other characteristic that bears on the length of time that a media asset is retained.

For example, if the assigned class is work-related messages, the media guidance application (e.g., via processing circuitry 306 (FIG. 3)) may retain the media asset (e.g., in storage 308 (FIG. 3)) indefinitely. If the assigned class is family-related messages, the media guidance application (e.g., via processing circuitry 306 (FIG. 3)) may retain the media asset (e.g., in storage 308 (FIG. 3)) for three days. If the assigned class is a default class (e.g., a class associated with an unknown entity), the media guidance application (e.g., via processing circuitry 306 (FIG. 3)) may retain the media asset (e.g., in storage 308 (FIG. 3)) for one day, unless the user accesses the media asset within that one day.

At step 508, the media guidance application stores the media asset in the storage circuitry for the determined length of time. For example, upon determining a class of the entity and the length of time for retention and/or other user preferences associated with the received media asset, the media guidance application (e.g., via instructions issued by processing circuitry 306 (FIG. 3)) may store the media asset in a local (e.g., storage 308 (FIG. 3)) or remote (e.g., any location/device accessible via communications network 414 (FIG. 4)) storage device coupled to and/or accessible by the media asset.

In some embodiments, the media guidance application (e.g., via processing circuitry 306 (FIG. 3)) may further determine an actual length of time the media asset has been stored. For example, the media guidance application may incorporate (or processing circuitry (e.g., processing circuitry 306 (FIG. 3)) associated with the media guidance application may be coupled to) a clock or counter function or an application that tracks the actual length of time that a media asset has been stored. For example, upon receipt of a media asset, the media guidance application (e.g., via processing circuitry 306 (FIG. 3)) may timestamp the media asset.

The timestamp and/or value (e.g., in units of time) associated by the clock or counter function with the receipt of the media asset may then be compared with the current time and/or value associated by the clock or counter function. The actual length of time (e.g., determined by subtracting the current time and/or value from the timestamp and/or value associated with the receipt of the media asset) may then be compared (e.g., via processing circuitry 306 (FIG. 3)) by the media guidance application to the determined length of time. In response to determining that the actual length of time the media asset has been stored corresponds to the determined length of time, the media guidance application may (e.g., via instructions issued by processing circuitry 306 (FIG. 3)) delete the media asset from the storage circuitry (e.g., storage 308 (FIG. 3)).

In some embodiments, the determined length of time may be dynamically adjusted. For example, the media guidance application may adjust the determined length of time based on characteristics associated with the media asset (e.g., as discussed below in relation to FIG. 6). Additionally or alternatively, the media guidance application may dynamically adjust the determined length of time based on user actions associated with one or more characteristics of the media asset (or the media asset itself).

For example, the media guidance application may determine a length of time to retain a media asset as described above. After determining the length of time, and while the media asset is stored, a subsequent user action may cause the media guidance application to adjust the determined length of time. For example, the media guidance application may detect that a user has updated a contacts list or has updated a setting (e.g., via display 200 (FIG. 2)) that may affect the determined length of time. In response, to detecting a change in the contacts list or settings, the media guidance application may search for all media assets and determined lengths of time that may be affected. In response to identifying an affected media asset or determined length of time, the media guidance application may automatically (or after notifying a user) re-determine the length of time.

Additionally or alternatively, the media guidance application may dynamically adjust the contacts lists or settings based on a user action. For example, in response to determining that a user has communicated with a particular entity recently, the media guidance application may automatically update the contacts lists, settings, class, etc. associated with the entity. For example, if a user has recently communicated with an entity, a media asset from the entity may be retained longer length of time, whereas if the user has not recently communicated with the entity the media asset may be retained for a shorter length of time.

In another example, if a user has recently shown interest in a characteristic associated with media assets (e.g., a genre, platform, etc.) the media guidance application may automatically update the affect a corresponding characteristic in associated with a media asset has on the determined length of time. For example, if a user stops accessing his/her social network page and/or stop using (or uses with less frequency) a social media application, the media guidance application may adjust the length of time that media asset associated with the social network page or application are retained.

It is contemplated that the steps or descriptions of FIG. 5 may be used with any other embodiment of this disclosure. In addition, the steps and descriptions described in relation to FIG. 5 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one of more of the steps in FIG. 5.

FIG. 6 is a flowchart of illustrative steps for modifying a determined length of time for storing a media asset based on characteristics associated with the media asset. It should be noted that process 600 or any step thereof could be performed on, or provided by, any of the devices shown in FIGS. 3-4. For example, process 600 may be executed by control circuitry 304 (FIG. 3) as instructed by a media guidance application implemented on a user device (e.g., user equipment devices 402, 404, and/or 406 (FIG. 4)) in order to determine whether to retain media assets (e.g., as discussed in relation to FIGS. 1-2). In addition, one or more steps of process 600 may be incorporated into or combined with one or more steps of any other process or embodiment (e.g., process 500 (FIG. 5)).

At step 602, the media guidance application determines a length of time to retain the media asset. For example, as discussed in relation to step 506 (FIG. 5)), the media guidance application may cross-reference (e.g., via processing circuitry 306 (FIG. 3)) a class (e.g., associated with a entity that transmitted the media asset to a user) with a database listing lengths of time for retaining content from different classes to determine a length of time to retain the media asset.

The values outputted from the database may indicate the length of time that the media asset should be retained. Additionally or alternatively, the outputted values may indicate any other user preferences associated with the class. For example, the user preference for the class may indicate particular keywords, files sizes, files types, and/or any other characteristic that bears on the length of time that a media asset is retained.

In another example, upon receipt of the media asset, the media guidance application (e.g., via processing circuitry 306 (FIG. 3)) may assign a default length of time to retain the media asset. For example, in some embodiments, the media guidance application may initially store all media assets for a predetermined time period (e.g., three days) and modify the predetermined time period based on one or more characteristics associated with the media asset.

At step 604, the media guidance application determines whether or not to modify the determined length of time based on a keyword. For example, the media guidance application (e.g., via processing circuitry 306 (FIG. 3)) may identify a keyword associated with the media asset and compare the keyword to a user preference for keywords (e.g., retrieved from a user profile in local (e.g., storage 308 (FIG. 3)) and/or remote (e.g., any location/device accessible via communications network 414 (FIG. 4)) storage. The media guidance application (e.g., via processing circuitry 306 (FIG. 3)) may determine a length of time, or modify a determined length of time, to retain the media asset based on the keyword comparison.

If the media guidance application determines to modify the determined length of time based on a keyword, the media guidance application proceeds to step 606. If the media guidance application determines not to modify the determined length of time based on a keyword, the media guidance application proceeds to step 610. At step 606, the media guidance application compares one or more keywords associated with the media asset to user preferences for keywords. For example, the media guidance application may compare (e.g., via processing circuitry 306 (FIG. 3)) the one or more keywords associated with the media asset to keyword lists (e.g., retrieve from local (e.g., storage 308 (FIG. 3)) and/or remote (e.g., any location/device accessible via communications network 414 (FIG. 4)) storage) to determine the affect of the keywords, if any, on the determined length of time.

In some embodiments, the media guidance application may compare (e.g., via processing circuitry 306 (FIG. 3)) keywords detected in a media asset to multiple keyword lists (e.g., retrieve from local (e.g., storage 308 (FIG. 3)) and/or remote (e.g., any location/device accessible via communications network 414 (FIG. 4)) storage) to determine the effect of the keywords, if any, on the determined length of time. For example, the media guidance application may compare a keyword to a white-list and/or a black-list. The white-list may include keywords the presence of which increases the amount of time that a media asset is retained.

At step 608, the media guidance application modifies the determined length of time based on the comparison. For example, if the media guidance application determines (e.g., via processing circuitry 306 (FIG. 3)) that a keyword associated with the media asset corresponds to a keyword in the user preferences for keywords, the media guidance application may modify (e.g., via processing circuitry 306 (FIG. 3)) the determined length of time accordingly.

In some embodiments, the media guidance application (e.g., via processing circuitry 306 (FIG. 3)) may employ various techniques for determining the length of time to retain the media asset. For example, the media guidance application may score each media asset based on the number of keywords matching one or more lists. In addition, particular keywords may be weighed differently according to the likelihood that their presence indicates a user would prefer or not prefer a media asset (or for a media asset to be stored). In some embodiments, the score associated with keyword matches from a first list may be combined with the score associated with keyword matches from a second list. For example, keyword from one list may be used to increase or decrease the overall score of the media asset.

In some embodiments, the weights associated with keywords, the presence of keywords on one or more lists, and/or any other factor relevant to the score may be modified and updated by the media guidance application. For example, if a user overrides (e.g., via display 200 (FIG. 2)) a determined length of time to retain a media asset, the media guidance application may update the user preferences accordingly. For example, if a media asset (or a series of media assets) each contained a keyword that previously contained little weight, and the media guidance application receives a user input increasing the time the media asset (or the series of media assets) is retained, the media guidance application may adjust the weight of the keyword.

At step 610, the media guidance application determines whether or not to modify the determined length of time based on a context associated with the media asset. For example, the media guidance application (e.g., via processing circuitry 306 (FIG. 3)) may identify a context associated with the media asset and compare the context to a user preference for contexts (e.g., retrieved from a user profile in local (e.g., storage 308 (FIG. 3)) and/or remote (e.g., any location/device accessible via communications network 414 (FIG. 4)) storage. The media guidance application (e.g., via processing circuitry 306 (FIG. 3)) may then determine a length of time, or modify a determined length of time, to retain the media asset based on the comparison.

If the media guidance application determines to modify the determined length of time based on the context of the media asset, the media guidance application proceeds to step 612. If the media guidance application determines not to modify the determined length of time based on the context of the media asset, the media guidance application proceeds to step 616. At step 612, the media guidance application compares (e.g., via processing circuitry 306 (FIG. 3)) the context associated with the media asset to user preferences for contexts. For example, the media guidance application may determine (e.g., via processing circuitry 306 (FIG. 3)) a media asset to have a particular context (e.g., a funny video, a time-dependent news alert, a work-related e-mail, a social media status update, etc.) based on one or more of the content recognition techniques discussed above. Upon determining the context of the media asset, the media guidance application may compare the context of the media asset to the user preference for contexts of media assets (e.g., retrieve from local (e.g., storage 308 (FIG. 3)) and/or remote (e.g., any location/device accessible via communications network 414 (FIG. 4)) storage) to determine the effect of the context, if any, on the determined length of time.

At step 614, the media guidance application modifies the determined length of time based on the comparison. For example, if the media guidance application determines (e.g., via processing circuitry 306 (FIG. 3)) that the context associated with the media asset corresponds to a user preference (e.g., an increase or decrease to the retention time of the media asset), the media guidance application may modify (e.g., via processing circuitry 306 (FIG. 3)) the determined length of time accordingly. As discussed above, the media guidance application (e.g., via processing circuitry 306 (FIG. 3)) may score the media asset based on the comparison.

At step 616, the media guidance application determines whether or not to modify the determined length of time based on a file type associated with the media asset. For example, the media guidance application (e.g., via processing circuitry 306 (FIG. 3)) may identify a file type associated with the media asset and compare the file type to a user preference for file types (e.g., retrieved from a user profile in local (e.g., storage 308 (FIG. 3)) and/or remote (e.g., any location/device accessible via communications network 414 (FIG. 4)) storage. The media guidance application (e.g., via processing circuitry 306 (FIG. 3)) may then determine a length of time, or modify a determined length of time, to retain the media asset based on the comparison.

If the media guidance application determines to modify the determined length of time based on the context of the media asset, the media guidance application proceeds to step 618. If the media guidance application determines not to modify the determined length of time based on the file type of the media asset, the media guidance application proceeds to step 622. At step 618, the media guidance application compares (e.g., via processing circuitry 306 (FIG. 3)) the file type associated with the media asset to user preferences for file types. For example, the media guidance application may determine (e.g., via processing circuitry 306 (FIG. 3)) a media asset to have a particular file type (e.g., .doc, .pdf, etc.). Upon determining the file type of the media asset, the media guidance application may compare the file type of the media asset to the user preference for file types of media assets (e.g., retrieve from local (e.g., storage 308 (FIG. 3)) and/or remote (e.g., any location/device accessible via communications network 414 (FIG. 4)) storage) to determine the affect of the context, if any, on the determined length of time.

At step 620, the media guidance application modifies the determined length of time based on the comparison. For example, if the media guidance application determines (e.g., via processing circuitry 306 (FIG. 3)) that the file type associated with the media asset corresponds to a user preference (e.g., an increase or decrease to the retention time of the media asset), the media guidance application may modify (e.g., via processing circuitry 306 (FIG. 3)) the determined length of time accordingly. As discussed above, the media guidance application (e.g., via processing circuitry 306 (FIG. 3)) may also score the media asset based on the comparison.

At step 622, the media guidance application determines whether or not to modify the determined length of time based on a storage requirement associated with the media asset. For example, the media guidance application (e.g., via processing circuitry 306 (FIG. 3)) may identify a storage requirement associated with the media asset and compare the storage requirement to a user preference for storage requirements (e.g., retrieved from a user profile in local (e.g., storage 308 (FIG. 3)) and/or remote (e.g., any location/device accessible via communications network 414 (FIG. 4)) storage. The media guidance application (e.g., via processing circuitry 306 (FIG. 3)) may then determine a length of time, or modify a determined length of time, to retain the media asset based on the comparison.

If the media guidance application determines to modify the determined length of time based on the context of the media asset, the media guidance application proceeds to step 624. If the media guidance application determines not to modify the determined length of time based on the storage requirement of the media asset, the media guidance application proceeds to step 628. At step 624, the media guidance application compares (e.g., via processing circuitry 306 (FIG. 3)) the storage requirement associated with the media asset to user preferences for storage requirements. For example, the media guidance application may determine (e.g., via processing circuitry 306 (FIG. 3)) a media asset to have a particular size. Upon determining the storage requirement of the media asset, the media guidance application may compare the storage requirement of the media asset to the user preference for storage requirements of media assets (e.g., retrieve from local (e.g., storage 308 (FIG. 3)) and/or remote (e.g., any location/device accessible via communications network 414 (FIG. 4)) storage) to determine the effect of the context, if any, on the determined length of time.

At step 626, the media guidance application modifies the determined length of time based on the comparison. For example, if the media guidance application determines (e.g., via processing circuitry 306 (FIG. 3)) that the storage requirement associated with the media asset corresponds to a user preference (e.g., an increase or decrease to the retention time of the media asset), the media guidance application may modify (e.g., via processing circuitry 306 (FIG. 3)) the determined length of time accordingly. As discussed above, the media guidance application (e.g., via processing circuitry 306 (FIG. 3)) may also score the media asset based on the comparison.

At step 628, the media guidance application determines an actual length of time the media asset has been stored. For example, as discussed above, in some embodiments, the media guidance application (e.g., via processing circuitry 306 (FIG. 3)) may further determine an actual length of time the media asset has been stored. For example, the media guidance application may incorporate (or processing circuitry (e.g., processing circuitry 306 (FIG. 3)) associated with the media guidance application may be coupled to) a clock or counter function or an application that tracks the actual length of time that a media asset has been stored. For example, upon receipt of a media asset, the media guidance application (e.g., via processing circuitry 306 (FIG. 3)) may timestamp the media asset.

The timestamp and/or value (e.g., in units of time) associated by the clock or counter function with the receipt of the media asset may then be compared with the current time and/or value associated by the clock or counter function. The actual length of time (e.g., determined by subtracting the current time and/or value from the timestamp and/or value associated with the receipt of the media asset) may then be compared (e.g., via processing circuitry 306 (FIG. 3)) by the media guidance application to the determined length of time. In response to determining that the actual length of time the media asset has been stored corresponds to the determined length of time, the media guidance application may (e.g., via instructions issued by processing circuitry 306 (FIG. 3)) delete the media asset from the storage circuitry (e.g., storage 308 (FIG. 3)).

At step 630, the media guidance application determines whether or not the actual length of time corresponds to the determined length of time. If the actual length of time corresponds to the determined length of time (e.g., the actual length of time equals or exceeds the determined length of time), the media guidance application proceeds to step 632 and deletes the media asset from storage. In contrast, if the actual length of time does not correspond to the determined length of time (e.g., the actual length of time is less than the determined length of time), the media guidance application returns to step 628.

It is contemplated that the steps or descriptions of FIG. 6 may be used with any other embodiment of this disclosure. In addition, the steps and descriptions described in relation to FIG. 6 may be done in alternative orders or in parallel to further the purposes of this disclosure. For example, each of these steps may be performed in any order or in parallel or substantially simultaneously to reduce lag or increase the speed of the system or method. Furthermore, it should be noted that any of the devices or equipment discussed in relation to FIGS. 3-4 could be used to perform one or more of the steps in FIG. 6.

The above-described embodiments of the present disclosure are presented for purposes of illustration and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real-time. It should also be noted, the systems and/or methods described above may be applied to, or used in accordance with, other systems and/or methods.

1. A method for retaining media content, the method comprising:
receiving, at an account associated with a user, a media asset addressed to the user from an entity;
identifying, using processing circuitry, a class of the entity based on a comparison of the entity with a contacts list associated with the user, wherein the contacts list is stored in storage circuitry associated with the account;
cross-referencing, using the processing circuitry, the class with a database listing lengths of time for retaining content from different classes to determine a length of time to retain the media asset; and
storing the media asset in the storage circuitry for the determined length of time.

2. The method of claim 1 further comprising:
determining an actual length of time the media asset has been stored;
comparing the actual length of time the media asset has been stored to the determined length of time; and
in response to determining that the actual length of time the media asset has been stored corresponds to the determined length of time, deleting the media asset from the storage circuitry.

3. The method of claim 1 further comprising:
identifying a keyword associated with the media asset;
comparing the keyword to a user preference for keywords; and
modifying the determined length of time based on the keyword comparison.

4. The method of claim 1 further comprising:
identifying a context associated with the media asset;
comparing the context of the media asset to a user preference for contexts of media assets; and
modifying the determined length of time based on the context comparison.

5. The method of claim 1 further comprising:
identifying a file type associated with the media asset;
comparing the file type of the media asset to a user preference for file types; and
modifying the determined length of time based on the file type comparison.

6. The method of claim 1 further comprising:
identifying a storage requirement associated with the media asset;
comparing the storage requirement of the media asset to a user preference for storage requirements; and
modifying the determined length of time based on the file type comparison.

7. The method of claim 1, wherein the entity includes an advertiser, a content provider, or another user.

8. The method of claim 1 further comprising generating for display a media asset identifier associated with the media asset on a user interface for the determined length of time.

9. The method of claim 8, wherein the media asset identifier is generated for display on a social networking page associated with a user that received the media asset.

10. The method of claim 1 further comprising adjusting the determined length of time based on whether the user accesses the media asset during the determined length of time.

11. A system for retaining media content, the system comprising:
storage circuitry configured to:
store a media asset for a length of time; and
store a database listing lengths of time for retaining content from different classes; and
processing circuitry configured to:
receive, at an account associated with a user, the media asset addressed to the user from an entity;
identify a class of the entity based on a comparison of the entity with a contacts list associated with the user, wherein the contacts list is stored in storage circuitry associated with the account; and
cross-reference the class with the database to determine the length of time to retain the media asset.

12. The system of claim 11, wherein the processing circuitry is further configured to:
determine an actual length of time the media asset has been stored;
compare the actual length of time the media asset has been stored to the determined length of time; and
in response to determining that the actual length of time the media asset has been stored corresponds to the determined length of time, delete the media asset from the storage circuitry.

13. The system of claim 11, wherein the processing circuitry is further configured to:
identify a keyword associated with the media asset;
compare the keyword to a user preference for keywords; and
modify the determined length of time based on the keyword comparison.

14. The system of claim 11, wherein the processing circuitry is further configured to:
identify a context associated with the media asset;
compare the context of the media asset to a user preference for contexts of media assets; and
modify the determined length of time based on the context comparison.

15. The system of claim 11, wherein the processing circuitry is further configured to:
identify a file type associated with the media asset;
compare the file type of the media asset to a user preference for file types; and
modify the determined length of time based on the file type comparison.

16. The system of claim 11, wherein the processing circuitry is further configured to:
identify a storage requirement associated with the media asset;
compare the storage requirement of the media asset to a user preference for storage requirements; and
modify the determined length of time based on the file type comparison.

17. The system of claim 11, wherein the entity includes an advertiser, a content provider, or another user.

18. The system of claim 11, wherein the processing circuitry is further configured to generate for display a media asset identifier associated with the media asset on a user interface for the determined length of time.

19. The system of claim 18, wherein the media asset identifier is generated for display on a social networking page associated with a user that received the media asset.

20. The system of claim 11, wherein the processing circuitry is further configured to adjust the determined length of time based on whether the user accesses the media asset during the determined length of time.

21-50. (canceled)
